(19) United States
(12) Patent Application Publication
(10) Pub. No.: US 2008/0111347 A1
(43) Pub. Date: May 15, 2008

(54) Universal step bumper receiver style trailer hitch

(76) Inventor: David Dwayne Tunno, Ventura, CA (US)

Correspondence Address: David Tunno, 1198 Navigaton Dr. # 70, Ventura, CA, 93001, US

(21) Appl. No.: 11/985,195

(22) Filed: Nov. 13, 2007

Related U.S. Application Data
(60) Provisional application No. 60/858,985, filed on Nov. 14, 2006.

(51) Int. Cl. B60D 1/56

(52) U.S. Cl. 280/504

(57) ABSTRACT

A receiver style hitch applicable to a step type vehicle bumper that mounts to the step portion of the bumper only by means of the existing hole intended for a ball hitch.

### CROSS-REFERENCE TO RELATED APPLICATIONS

This application claims the benefits of provisional patent application Ser. No. 60/858,985.

### BACKGROUND OF THE INVENTION

1. Field of the Invention

This invention relates to receiver style trailer hitches, specifically to such hitches designed to be used in conjunction with step type vehicle bumpers.

2. Prior Art

The prior art for trailer hitches in general includes many designs that mount to the vehicle at multiple contact points, such as the frame and the bumper. Due in part to the wide variety of vehicle designs, varieties of designs for these types of trailer hitches are extensive, as they must include dimensions and features to fit the variety of configurations in vehicles. These are relatively complex units that are large, relatively expensive and relatively difficult to install, requiring the boring of holes in the vehicle frame and elsewhere and/or welding. They require, for the most part, professional installation. The variety of designs also makes stocking these types in auto parts stores relatively impractical and more costly.

The more specific area of prior art relevant to the disclosed invention is a receiver style trailer hitch designed to mount specifically to a step type bumper. Its connection is only to the step portion of the bumper and so is comparatively simple, inexpensive and easier to install than the types described above. Examples of this type of hitch include the Valley Industries models 75280 and 76030 and the Curt Manufacturing models E-3S and E3WS.

While these examples provide advantages in cost and ease of installation over the larger more complex types described earlier, they require that a specific pattern of holes pre-exist in the step portion of the bumper, or those holes must be drilled through the heavy gauge steel of the step portion of the bumper by the installer. Each of these models features a broad, flat mounting surface that is suitable for mounting to a variety of step bumpers, but may be unsuitable to many step bumper designs due to irregularities in the under surface of the step portion of those bumpers.

### OBJECTS AND ADVANTAGES

There comes then a need for a receiver step bumper hitch with the following objects and advantages:

(1) It is mountable to a wide variety of existing step bumpers.

(2) It mounts to the bumper by means of the existing hole intended for a ball hitch.

(3) It does not require drilling holes in the step bumper for mounting.

(4) It is easy to install with ordinary tools.

Further objects and advantages are to provide a hitch that is inexpensive to purchase and install. Another advantage of the invention is that, because it fits a wide variety of existing step bumpers, it is less expensive to stock in inventory at a retail outlet.

### SUMMARY

In accordance with the present invention, a receiver style trailer applicable to a step type bumper that mounts to the step portion of the bumper only by means of the existing hole intended for a ball hitch.

### BRIEF DESCRIPTION OF THE DRAWINGS

FIG. 1 is a perspective view of the hitch.

FIG. 2 is a side view of the hitch attached to the step portion of a step bumper.

FIG. 2A is a detail side view of a portion of FIG. 2, showing the components that brace the hitch to the bumper.

FIG. 3 is a top view of the hitch attached to the step portion of a step bumper.

FIG. 4 is a cutaway view of the hitch attached to the step portion of a step bumper.

FIG. 5 is a cutaway view of the hitch attached to the step portion of a step bumper.

FIG. 6 is a cutaway view of an alternate embodiment of the hitch attached to the step portion of a step bumper.

FIG. 7 is a cutaway view of an alternate embodiment of the hitch attached to the step portion of a step bumper.

FIG. 8 is a perspective view of an alternate embodiment of the hitch.

### DETAILED DESCRIPTION OF THE PREFERRED EMBODIMENTS

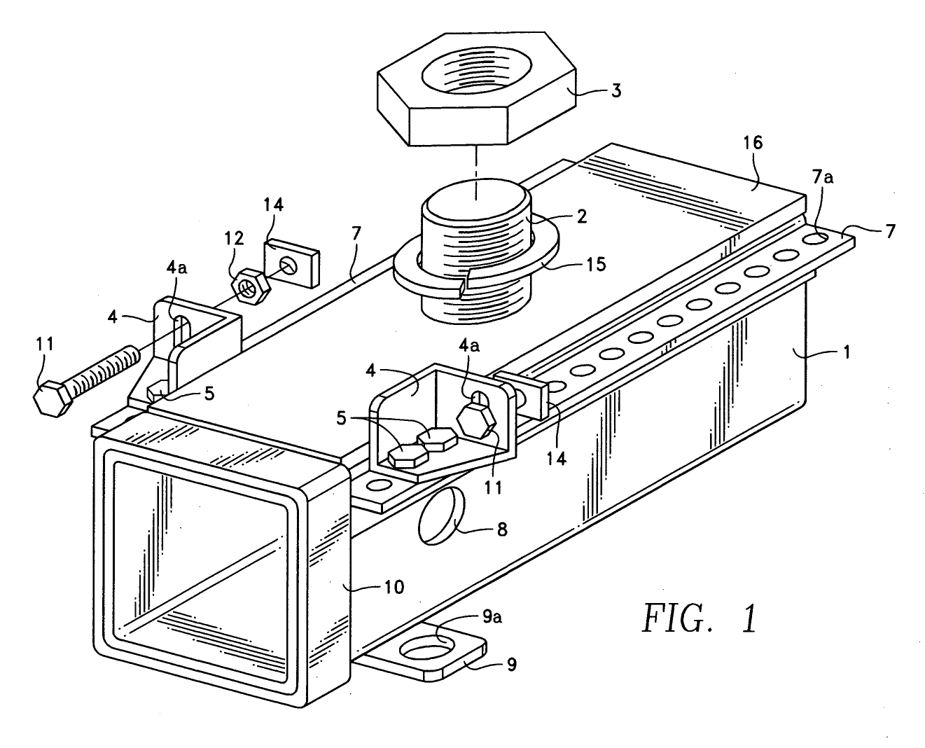

Referring now to the drawings, where preferred embodiments of the hitch are illustrated in FIG. 1 through FIG. 8 in accordance with the present invention.

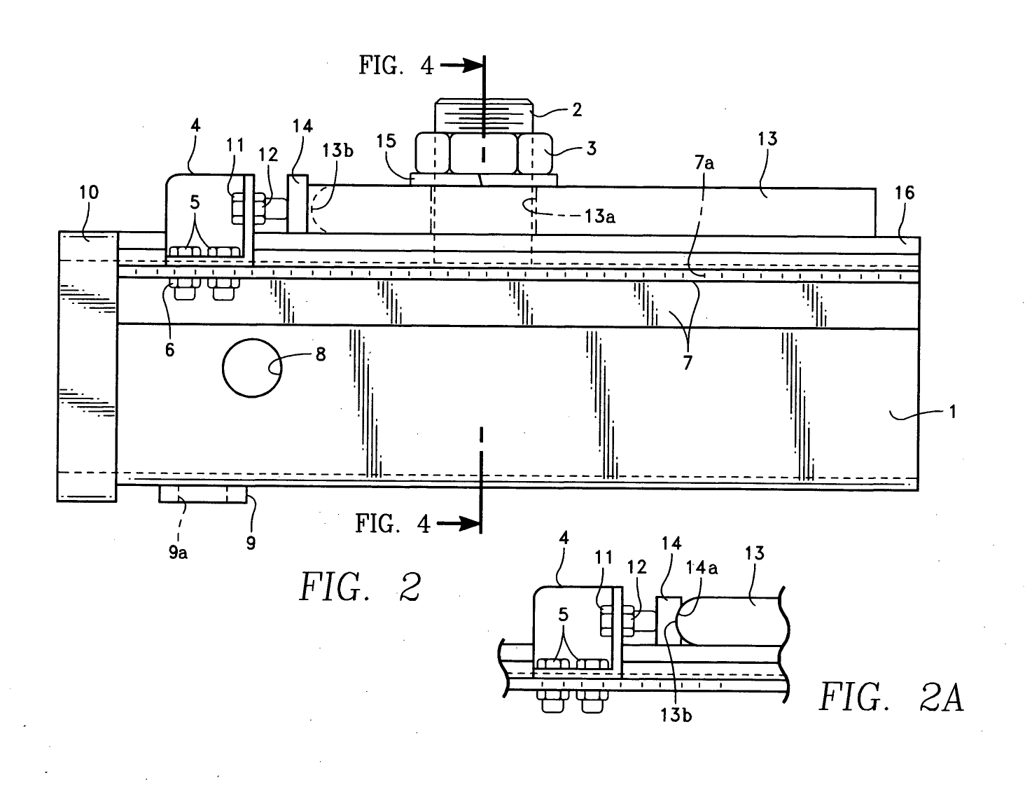

FIG. 1 shows an embodiment of the hitch in a perspective view. The hitch includes receiver tube 1. Attached, preferably by welding, to the upper portion of both sides of receiver tube 1 are rails 7 with holes 7a, which are used to mount bracing brackets 4 to rails 7 by means of bolts 5 and nuts 6 (see FIG. 2.)

Also attached to receiver tube 1, preferably by welding, is reinforcing plate 16. Plate 16 ads strength to the assembly, most notably to the attachment of stud 2 to the assembly as will be further described in connection with subsequent illustrations.

As shown in subsequent figures, bolts 11, backing nuts 12 and shims 14 are used to apply pressure to the proximal edge of the step portion of the bumper. Pressure on the proximal and/or distal edges of the step portion of the bumper counteracts lateral forces that would otherwise tend to twist the hitch about the axis of stud 2, which protrudes through the step portion of the bumper from underneath it, through the hole intended for a ball hitch and is mounted to the step portion of the bumper by means of nut 3 and lock washer 15.

Rails 7 may extend the full length of receiver tube 1 from reinforcement band 10 to the distal end of receiver tube 1. This allows bracing brackets 4 and the components that accompany them at either or both ends of rails 7 in order to apply bracing pressure to the proximal and/or distal edges of the step portion of the bumper. Alternatively, rails 7 may also be fixed to either end of receiver tube 1, so as to apply bracing pressure to either the proximal or distal edges of the step portion of the bumper. Rails 7 may also be fixed to both ends, with an open space between sections of rails 7, so as to mount bracing brackets 4 to apply pressure to both the proximal and distal edges of the step portion of the bumper.

In the FIG. 1 embodiment, the holes that receive bolts 11 are not threaded. Nut 12, therefore, provides the adjustable pressure of bolts 11 to the shims and therefore the step portion of the step bumper 13.

In an alternative embodiment, the hitch can be produced without adjustable bracing components for those step bumpers with known distances between the hole intended for a ball hitch and the proximal and/or distal edges of the step bumper. If desired, a hitch for those bumpers can include a solid brace, such as a lateral cross bar welded or otherwise fixed to the receiver tube across its upper surface, at the point where the proximal and/or distal edges of the step bumper cross the receiver tube, so as to provide resistance against the same lateral forces described above. For bumpers made from shaped metal where the contact with the receiver tube is an edged that has been rolled under, the lateral cross bar may be welded or otherwise fixed to receiver tube so as to contact that rolled-under edge and thus be hidden from view. Those skilled in the art will understand that alternative designs for bracing the hitch against the bumper may be employed without departing from the teachings or spirit of the present invention.

Also visible in FIG. 1 is safety chain receiver plate 9 with holes 9A. In this embodiment, plate 9 is welded to the bottom surface of receiver tube 1 and extends an equivalent length beyond each side. It is understood that the art teaches various other designs for incorporating safety chain receivers on a hitch which would also be acceptable when applied to the present invention.

FIG. 2 is a side view of the hitch attached to the step portion of a step bumper. Stud 2, which is affixed to receiver tube 1, protrudes through the hole in the step portion of the bumper intended for a ball hitch and is attached by means of nut 3 and lock washer 15.

The hitch includes holes 8 in receiver tube 1 to receive a standard-sized retainer pin.

In FIGS. 2 and 2A, the step portion of the bumper has a curved proximal edge 13b. FIG. 2A shows the use of shims 14 placed between bolt 11 and the edge of the bumper so as to spread the force of bolt 11 along the edge of the bumper and also to protect the surface against marring caused by the pressure of bolt 11. In the FIG. 2A example, shims 14 include curved surfaces 14a to accommodate the curved surface of the bumper. Other bumper edge surface shapes exists and it is advisable to include shims with different shapes to accommodate them.

Preferably, the shims include a round depression, as can be seen in FIG. 1, to receive the ends of bolts 11 so as to keep the shims in position between the bolts and the bumper. It is also possible to apply the desired bracing force with bolts 11, but without the use of shims.

Due to the variety of shapes and thicknesses of the step portion of bumpers, it is preferred that bolts 11 be adjustable as to height relative to the base of bracing brackets 4. This will allow bolts 1, with or without shims, to be better positioned to apply pressure to the bumper. One way to achieve this adjustability is to make slotted holes 4a through which bolts 11 pass through bracing brackets 4, as shown in FIG. 1.

FIG. 3 is a top view of the hitch, also showing the step portion of the bumper to which it is mounted. In this embodiment, as described earlier, rails 7 extend the full length of the hitch from reinforcing band 10 to the distal end of the hitch. As previously described, the portion of the hitch covered by the step portion of the bumper need not include rails 7. The distance from the center of the hole in a step bumper that is intended for a ball hitch and the proximal edge of the step portion of the bumper (13b in FIG. 2), varies by make and model. This variety necessitates the adjustability of the bracing assembly, which in this embodiment is accommodated by means of rails 7 with holes 7a.

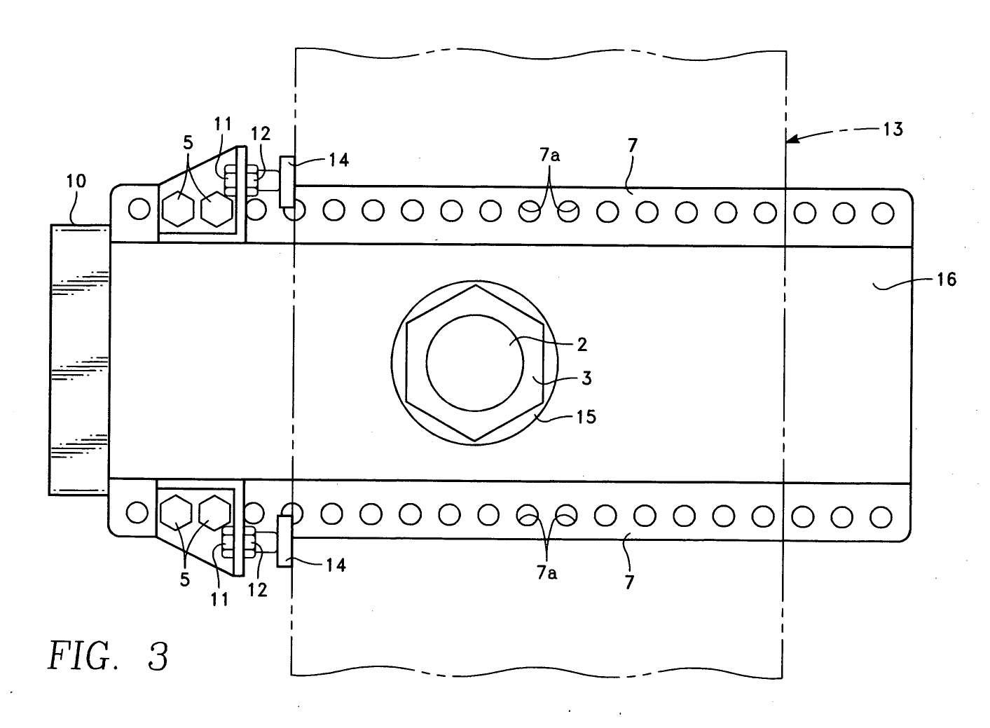

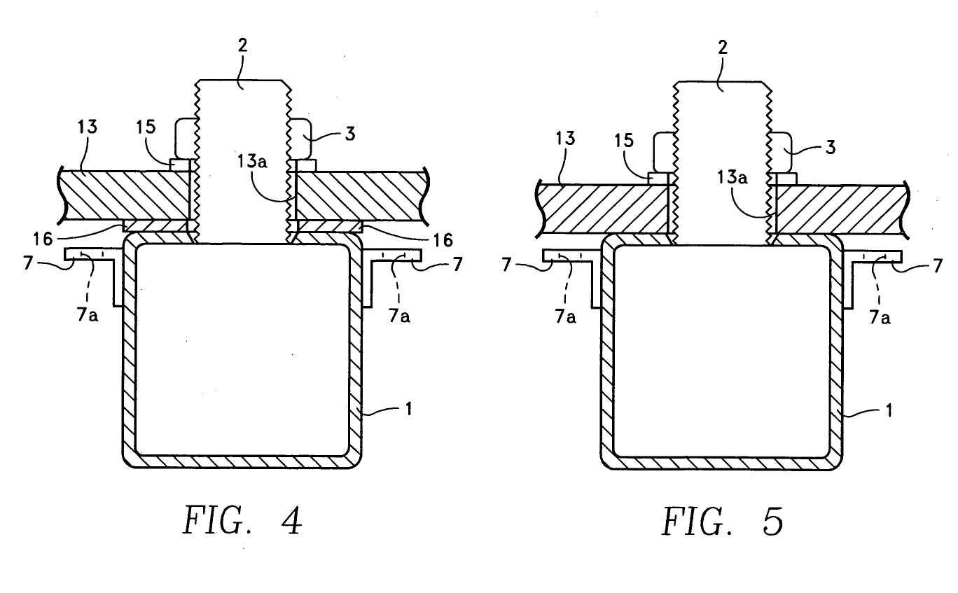

FIG. 4 is a cutaway view of an embodiment of the hitch. This embodiment includes reinforcing plate 16, which is preferably welded to receiver tube 1 and stud 2 is welded to receiver tube 1 and reinforcing plate 16 at the bottom of opening 13a where it passes through receiver tube 1 and reinforcing plate 16. Where hole 13a passes through receiver tube 1, it is preferably chamfered, as shown in FIGS. 4 and 5 to facilitate welding it to receiver tube 1 without allowing the weld to penetrate into the interior of receiver tube 1, which would require removal so as to allow the receiver tube to receive an insert. Hole 13a, where it passes through reinforcing plate 16 is preferably large enough to act as a window weld, further strengthening the bond of reinforcing plate 16 to receiver tube 1, whereas reinforcing plate 16 is also preferably welded to receiver tube 1 along the outer edge.

FIG. 5 is a cutaway view of an alternate embodiment of the hitch without reinforcing plate 16.

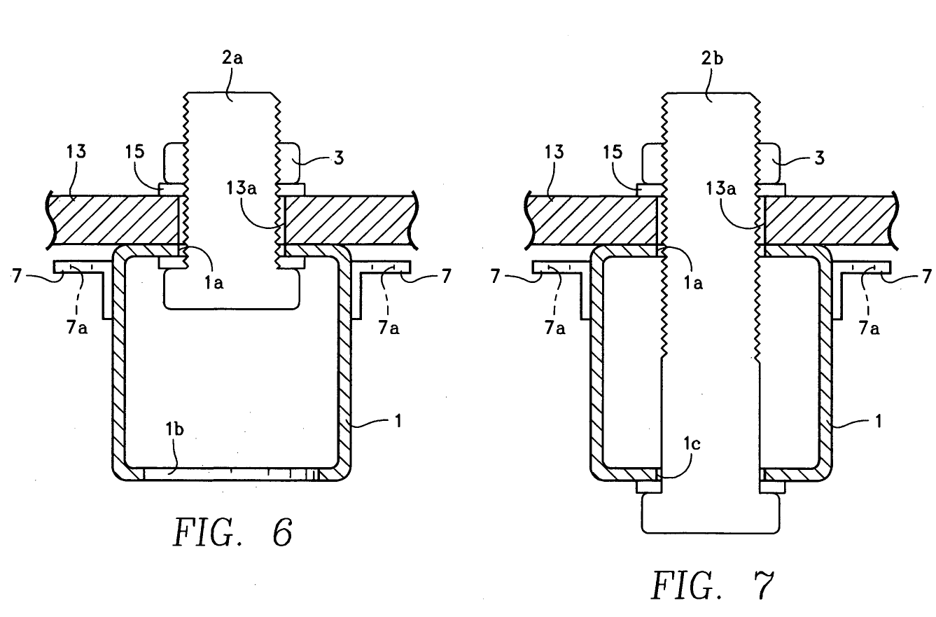

FIG. 6 is a cutaway view of an alternate embodiment of the hitch wherein 2a is a bolt that attaches the hitch to bumper 13 through hole 1a in receiver tube 1 and hole 13a in bumper 13. Hole 1b in the bottom surface of receiver tube 1 is large enough to insert bolt 2a through the bottom of the receiver tube, preferably with a socket wrench attached, through holes and 13a where it is then attached to bumper 13 with nut 3 and lock washer 15.

FIG. 7 is a cutaway view of an alternate embodiment of the hitch wherein 2b is a bolt that attaches the hitch to bumper 13. Bolt 2b passes completely through receiver tube 1 through holes 1c and 1a and bumper 13 through hole 13a.

The embodiments represented by FIGS. 6 and 7 require the proximal end of the hitch to be long enough to allow it to fully receive an insert retained in place by a pin through hole 8 (see FIGS. 1 and 2.) The advantage of these two embodiments is in the fact that welding of the mounting stud is not required. The function of welded stud 2 in previously described embodiments is replaced by mounting bolts 2a and 2b. A further advantage of these embodiments is that reinforcing plate 16 is not required, as its primary purpose was to reinforce the union of stud 2 to receiver tube 1 as shown in previous figures.

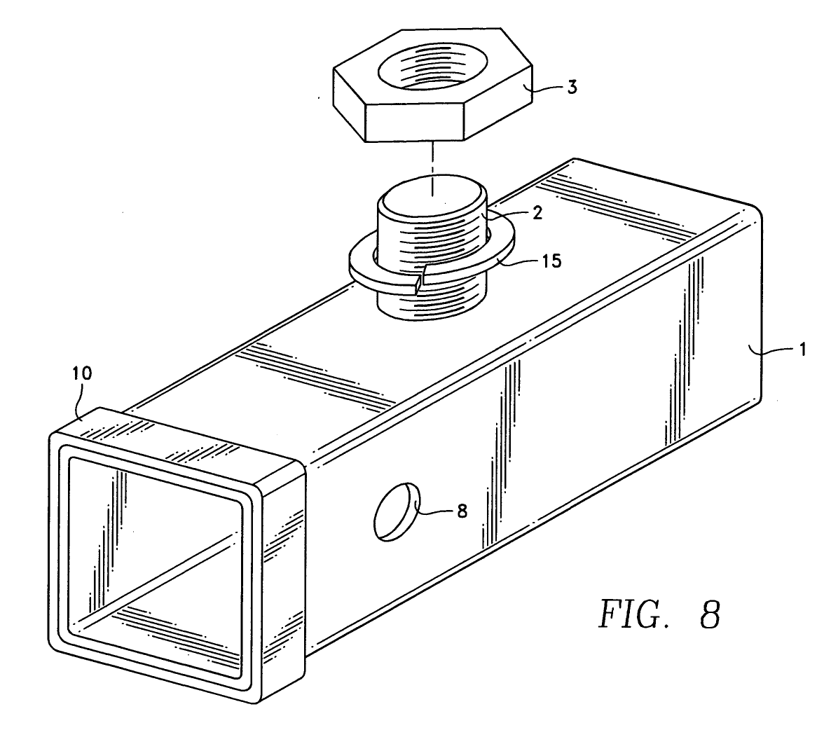

FIG. 8 is a perspective view of an alternate embodiment of the hitch. This embodiment does not include reinforcing plate 16, rails 7, or any of the components associated with bracing against the bumper to counter lateral forces. This embodiment is for light duty towing (if at all), but also for non-towing uses, such as bicycle racks and other accessories specifically made for receiver style hitches.

The foregoing has been a description of the preferred embodiment of the present invention. It is understood that those skilled in the art may depart from the descriptions of the preferred embodiment without departing from the spirit of the invention or scope of the claims.

What is claimed:

1. A receiver hitch mountable to a vehicle utilizing only the existing hole intended for a ball hitch.

2. The receiver hitch of claim 1 with means for bracing the hitch against the bumper to counteract lateral forces acting against the mounting point.

3. The receiver hitch of claim 2 wherein the means for bracing is adjustable to accommodate a variety of bumper dimensions.
